(19) United States
(12) Patent Application Publication
(10) Pub. No.: US 2024/0102919 A1
(43) Pub. Date: Mar. 28, 2024

(54) APPARATUS AND METHOD FOR ANALYZING A SAMPLE

(71) Applicant: HELSINGIN YLIOPISTO, HELSINGIN YLIOPISTO (FI)

(72) Inventor: Markku VAINIO, HELSINGIN YLIOPISTO (FI)

(21) Appl. No.: 18/286,319

(22) PCT Filed: Apr. 12, 2022
(86) PCT No.: PCT/FI2022/050243

§ 371 Date: Oct. 10, 2023

(30) Foreign Application Priority Data
Apr. 14, 2021 (FI) 20215442

(51) Int. Cl. G01N 21/17

(52) U.S. Cl. CPC G01N 21/1702; G01N 2021/1704

(57) ABSTRACT

An apparatus (100) for analyzing a sample, the apparatus comprising at least one light source (102) configured to emit non-thermal broadband electromagnetic radiation towards a sample and a cantilever-enhanced photoacoustic (CEPAS) detector (104) configured receive the sample and the electromagnetic radiation and to detect absorption of said electromagnetic by the sample.

### TECHNICAL FIELD OF THE INVENTION

The invention relates to analysis of samples in general. More specifically, the invention relates to an apparatus and method for analyzing a sample utilizing at least one non-thermal broadband light source and a cantilever-enhanced photoacoustic detector.

### BACKGROUND OF THE INVENTION

Analysis of gaseous samples is important in various fields, such as monitoring of air quality. Many different types of methods and devices are also available for this purpose. The use of lasers in combination with detectors is known to provide analysis of compounds in samples (such as concentration measurements) with high sensitivity. A specific laser wavelength may be used to detect a specific compound absorbing light at the used wavelength. Lasers are commonly used with photoacoustic detectors because the intensity of the obtained signal depends on the intensity of the light used, and lasers may provide the necessary light power for sufficient signal strength.

Laser-based methods are expensive to implement and additionally the use may be limited, as one laser source may only allow detection of one compound at a time. Thus, if more than one compound is to be detected, a plurality of different detection devices (or at least a plurality of different laser sources) should be used.

Attempts to provide devices for detection of components in gaseous compounds using more economical light sources than lasers exhibit only moderate sensitivity.

Especially considering the field of air quality measurements, the sensitivity offered by low-cost devices may be inadequate. Furthermore, there is often a desire to detect concentrations of a plurality of different compounds comprised in air. The assessment of air quality to a satisfactory degree may require the use of many different devices which all employ lasers, giving rise to a costly and complicated assembly.

It would be beneficial to provide an apparatus for analyzing a sample which would be cost-efficient to implement, yet would provide high sensitivity of measurements. Additionally, it would be beneficial to provide an apparatus which could be used for detection of a plurality of compounds in a sample.

### SUMMARY OF THE INVENTION

The object of the invention is to alleviate at least some of the problems in the prior art. In accordance with one aspect of the present invention, an apparatus is provided for analyzing a sample, the apparatus comprising at least one light source configured to emit non-thermal broadband electromagnetic radiation towards a sample and a cantilever-enhanced photoacoustic (CEPAS) detector configured to detect absorption of said electromagnetic by the sample.

A method for analyzing a sample is also provided according to independent claim 12.

A method and apparatus for analyzing a sample may be provided which may be more versatile than those known in the prior art and the apparatus may replace the use of a plurality of separate detection devices due to the ability to detect a plurality of compounds comprised in a sample.

The invention may also be utilized to provide an apparatus that is cheaper than those in the prior art and the apparatus may be readily miniaturized.

The combination of possibly low-cost light sources that are available in particular with e.g. LEDs and/or SLDs with the highly sensitive detection provided by CEPAS detectors has not been utilized in the prior art. Provision of an apparatus comprising a non-thermal light source producing incoherent or broadband electromagnetic radiation and a CEPAS detector could provide enhanced detection of different compounds in a sample. It was realized by the inventor that detection of compounds in a sample gas could also be made more cost-effective and simpler through this combination. The sensitivity of the CEPAS detector enables e.g. an LED (or other light source that may be used without providing the monochromatic and spectrally highly concentrated power of a traditional laser) to be used as a light source while sensitivity of the detection is retained at an adequate level.

Even embodiments where one or more light sources are more expensive than e.g. LEDs, such as supercontinuum or frequency comb laser, the apparatus could still provide a cost-effective alternative to solutions where a plurality of traditional monochromatic lasers would otherwise be used.

An apparatus may be used to detect compounds that absorb electromagnetic radiation at different frequencies due to the broad band (e.g. over 1 THz bandwidth) of electromagnetic radiation that may be provided through the non-thermal broadband light source, e.g. an LED, SLD, supercontinuum (laser) light source or optical frequency comb.

The CEPAS detector also provides an extensive linear dynamic range and may thus be utilized to accurately detect compounds of a sample that differ in concentration or absorbance even largely. For instance, concentrations ranging from relative concentration of 10⁻⁹ to 10⁻³ could be detected even simultaneously with the same apparatus.

Measurements relating to environmental gases in particular may involve measurements of a plurality of different compounds which may differ in properties and/or in concentration. Embodiments of the invention may provide possibilities for detecting a plurality of these different compounds and at differing concentrations.

In one embodiment, the CEPAS detector may comprise a sample chamber adapted to receive the sample, the sample chamber comprising at least one opening, e.g. window for allowing the electromagnetic radiation to enter the sample chamber. The CEPAS detector may additionally comprise a microphone arrangement comprising at least one aperture arranged in the sample chamber, said aperture having a cantilever coupled thereto which is configured to be movable in response to pressure variations occurring in the sample chamber due to the electromagnetic radiation being absorbed by the sample. The microphone arrangement may additionally comprise a measuring arrangement for measuring the movement of the cantilever. The cantilever advantageously comprises silicon.

An apparatus may additionally comprise means for modulating the electromagnetic radiation with at least one frequency, which may be in the range of 10 Hz-5 kHz.

An apparatus may comprise different means for modulating the electromagnetic radiation. The means for modulating may comprise at least one optical chopper and/or the modulating may comprise modulating electric current being passed to at least one light source utilized in the apparatus.

In one embodiment, an apparatus may be configured to provide a plurality of discrete or at least partially overlapping separate spectra of electromagnetic radiation separable into a plurality of different channels.

In one embodiment, the apparatus may be configured to detect a plurality of compounds simultaneously, and a plurality of separate spectra may be provided, where wavelengths of the different spectra may be selected to each be suitable for detecting one or more specific compounds. For instance, for detecting at least a first compound, at least one separate spectrum may comprise wavelengths that are essentially absorbed by the first compound, while at least one other separate spectrum may comprise wavelengths that are essentially not absorbed by the first compound.

Separate spectra may be provided by an apparatus comprising dedicated means for providing the spectra from e.g. one light source, such as through using one or more optical filters or the separate spectra may be provided by using a plurality of light sources.

In embodiments where separate spectra are provided, the apparatus may additionally be configured to modulate at least two of the separate spectra at different frequencies. Advantageously, all of the separate spectra that are provided may be modulated at different frequencies.

The apparatus may additionally comprise means for combining the separate spectra and the CEPAS detector may then be configured to receive the combined spectrum.

In the prior art, some apparatuses employing photoacoustic detectors utilize an acoustic resonator to enhance sensitivity of the measurements. Attempts to use non-laser light sources (specifically, light sources having power or intensity lower than traditional lasers) in combination with traditional photoacoustic detectors would have to employ such acoustic resonators to achieve detection thresholds that are usable in practical applications. In this case, only one modulation frequency can be used for modulating the light provided by the light source because the modulation frequency needs to be precisely adjusted to the frequency of the acoustic resonance. Therefore, these types of photoacoustic detectors and apparatuses are not suitable for applications where light is provided to separate channels with separate spectra and each is modulated at a different frequency.

In monitoring of air quality, compounds of interest that should be monitored can include particulate matter and gaseous compounds. Particles or compounds of interest may include e.g. road dust, fine particulate matter, and/or gaseous pollutants, such as nitrogen oxides (NOₓ). In particular, black carbon is particulate matter that is a significant pollutant and has adverse effects on health and when present in the atmosphere, enhances the greenhouse effect. NO₂ is specifically a notable pollutant in the group of nitrous oxides.

With the present invention, it may be possible to detect one or more compounds simultaneously, e.g. at least a first compound and a second compound, such as a species of particulate matter and one or more species of gaseous compounds simultaneously. For example, an apparatus may be configured to detect at least black carbon and one or more nitrogen oxides simultaneously.

An apparatus according to embodiments of the present invention may provide simultaneous and continuous detection of compounds in real-time.

The considered samples and particles or compounds of interest may be provided as a gaseous sample. The gaseous sample may e.g. comprise particulate matter suspended in air or other gas.

The exemplary embodiments presented in this text are not to be interpreted to pose limitations to the applicability of the appended claims. The verb “to comprise” is used in this text as an open limitation that does not exclude the existence of unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The presented considerations concerning the various embodiments of the apparatus may be flexibly applied to the embodiments of the method mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

s FIG. 1 schematically illustrates at least part of an apparatus according to one embodiment of the invention,

FIG. 2 depicts one alternative of an optical chopper that may be used as means for modulating in embodiments of the invention,

FIG. 3 schematically shows one more apparatus according to an embodiment of the invention,

FIG. 4 illustratively represents, at 4A and 4B, further apparatuses according to embodiments of the invention, and

FIG. 5 depicts a flow chart of a method according to one embodiment of the invention.

### DETAILED DESCRIPTION

FIG. 1 schematically depicts at least portion of an apparatus 100 according to one embodiment of the invention. The apparatus 100 comprises at least one light source 102 configured to emit non-thermal broadband electromagnetic radiation towards a sample. The light source 102 may be a light emitting diode (LED), superluminescent diode (SLD), supercontinuum (laser) light source, or optical frequency comb. Advantageously, “broadband” may refer to a spectrum of electromagnetic radiation comprising a bandwidth of at least 1 THz.

The apparatus additionally comprises a cantilever-enhanced photoacoustic (CEPAS) detector 104 configured to detect absorption of the electromagnetic radiation by the sample. One advantageous type of CEPAS detector is described e.g. in patent application WO200429594.

The apparatus 100 may be configured to receive or hold a gaseous sample that is to be analyzed with the apparatus 100. Usually, a sample cell 106 is provided in connection with the CEPAS 104.

The sample cell may comprise an opening 108 through which the light emitted by the light source 102 may enter the sample cell 106. The sample may comprise a constituent or compound that absorbs at least certain wavelengths of the electromagnetic radiation emitted by the light source 102 that are allowed to enter the sample cell 106.

The CEPAS detector may be configured to detect the absorption of the electromagnetic radiation by a microphone arrangement. The microphone arrangement may comprise at least an aperture in the sample chamber 106, where the aperture has a cantilever 110 coupled to it. In one advantageous embodiment, the cantilever comprises or is made of silicon. The cantilever is configured to be movable in response to pressure variations occurring in the sample chamber 106 due to the electromagnetic radiation being absorbed by the sample.

A sensitivity of measurements provided by the CEPAS detector may be so high that a detection threshold or concentration required for obtaining a signal via the detector may be sufficiently low even with the use of a light source having lower intensity than of traditional lasers may be successfully employed. For example, a detection threshold of about 1 ppb is required for detecting NO₂ in the atmosphere.

The dimensions of e.g. the aperture and/or the cantilever may be selected e.g. so that the cantilever has a surface area which is at most equal to that of the aperture. The cantilever may also be mounted on a frame structure that preferably also comprises silicon, encircling the cantilever.

The pressure variations in the sample chamber 106 may be accomplished by modulating the electromagnetic radiation provided by the light source 102.

For instance, if the modulation is carried out by cutting the radiation periodically with a frequency f, the pressure variations in the sample chamber 106 also occur at the frequency f if the sample in the chamber comprises constituent(s) that absorb said radiation at the provided wavelength(s). The microphone arrangement may detect the periodical pressure (i.e. acoustic) signal. A modulation frequency may be e.g. between 10 Hz-5 kHz.

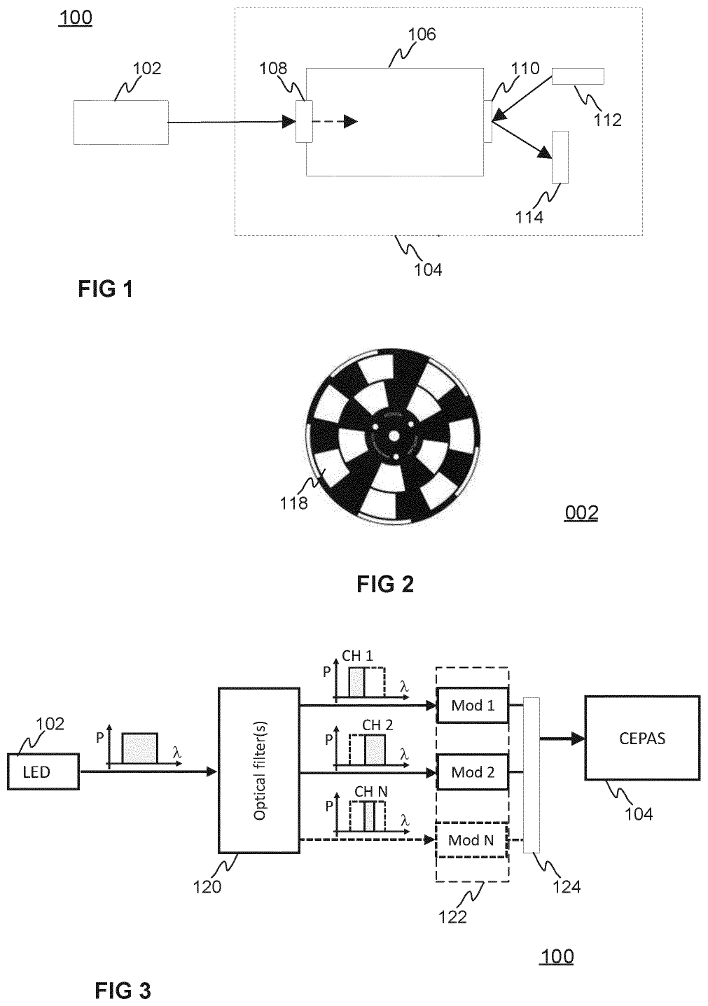

An apparatus may comprise means for modulating the light provided by the light source 102, such as one or more optical choppers, which may be mechanically operated. FIG. 2 depicts an optical chopper 002 that may be used in embodiments of the invention. The optical chopper 002 may comprise a metal plate that is configured to be rotated, the plate having holes 118 positioned periodically on the metal plate, such that as the plate is rotated in the path of light provided by the light source 102, the light is modulated by a selected frequency, which may depend on the placing of the holes 118 and the rotating speed of the optical chopper 002/metal plate.

The amplitude Aₓ of the movement of the cantilever may be optimized or maximized by optimizing the resonance angular frequency ω₀, surface area A, and thickness d of the cantilever 110.

The microphone arrangement may additionally comprise a measuring arrangement for measuring the movement of the cantilever 110 without being in physical contact with the cantilever. The measuring arrangement may for instance comprise an optical measuring arrangement or capacitive measuring arrangement.

In one embodiment, the measuring arrangement may comprise an optical measuring arrangement comprising at least a measuring light source 112, such as a laser and an optical sensor 114. The measuring arrangement may measure the movement of the cantilever 110 by observing, via the optical sensor 114, light generated by the measuring light source 112 being directed towards the cantilever and reflected from the cantilever 110.

An optical measuring arrangement may also comprise one or more lenses, at least one more further optical sensor, one or more mirrors, and/or one or more beam-splitters. An example of a suitable optical measuring arrangement utilizing an interferometer is given in WO200378946.

The microphone arrangement of the CEPAS detector 104, and specifically the use of the cantilever 110 in the detector enables the high sensitivity of the detector. A dynamic range of the CEPAS detector may comprise at least four orders of magnitude, preferably 4-10 orders of magnitude, such as about 5-6 orders of magnitude.

An apparatus 100 may additionally comprise or be associated with at least one processor for data analysis.

FIG. 3 shows a simplified view of one alternative embodiment of an apparatus 100, where the apparatus is configured to simultaneously detect a plurality of compounds present in the sample. The spectrum of electromagnetic radiation that is emitted by the non-thermal broadband light source 102 may be divided into a plurality of separate spectra of which at least one comprises only part of the entire spectrum provided by the light source 102. The wavelengths of light comprised in the separate spectra may be discrete or at least partially overlapping separate spectra of electromagnetic radiation that are separable into a plurality of different channels CH 1, CH 2, . . . , CH N.

The apparatus 100 thus may comprise means 120 for providing the separate spectra, which means 120 may comprise e.g. one or more optical filters. A filter may comprise a dichroic mirror, for instance. The spectrum of light provided by the light source 102 may be divided into at least two channels, optionally 3 or more channels.

The wavelengths of light comprised in each separate spectrum or channel may be selected based on the application, e.g. such that one or more compounds of interest in a sample may absorb said light.

In some embodiments, the apparatus 100 may be configured to detect at least a nitrous oxide and particulate matter. In an advantageous embodiment of the invention, the apparatus 100 may be configured to detect at least NO₂ and black carbon. In this case, a first channel CH 1 may comprise wavelengths in the range of e.g. about 400-500 nm, which is in a wavelength range where NO₂ strongly absorbs light. A second channel CH 2 may comprise wavelengths in the range of e.g. about 500-700 nm, advantageously comprising wavelengths that are essentially not absorbed by NO₂. Black carbon absorbs light essentially at all wavelengths, whereby CH 2 may comprise any of the wavelengths of light produced by the light source 102 but which are essentially not absorbed by NO₂. Of course, also e.g. a third channel could be provided for detecting a third, preferably gaseous compound such as ozone, with wavelength spectrum selected accordingly.

The separate channels CH 1, CH 2, . . . , CH N may be directed to means 122 for separately modulating the electromagnetic radiation of each channel. Each spectrum in each channel may advantageously be modulated by a different frequency. Therefore, e.g. the spectrum of the first channel CH 1 may be modulated according to a first frequency Mod 1 and the second channel CH 2 may be modulated according to a second frequency Mod 2. The means 122 for modulating may e.g. comprise an optical chopper 002 associated with each channel.

The modulating frequency is advantageously selected so that the signal-to-noise ratio of the CEPAS detector is as large as possible. This may mean using modulating frequencies that are under the resonance frequency of the cantilever of the CEPAS detector, which is usually under 1 kHz. Yet, at low frequencies, such as below 10 Hz, the level of noise may be high, whereby 10 Hz-1 kHz may be appropriate. A modulating frequency may be selected essentially arbitrarily and need not depend on the compound to be detected, but the modulation frequencies are preferably different for the different channels. Typically, a 1-10 Hz difference between channels for modulating frequencies is enough to allow separability of the compounds by the apparatus 100. In some cases, it may be advantageous to avoid modulating frequencies that correspond to frequencies of utilized mains current and its multiples.

After modulation, the channels CH 1, CH 2, . . . , CH N may be joined or combined, e.g. utilizing a similar component as is used in the means 120 for providing the separate channels but here to reverse the process. The apparatus may comprise means 124 for combining the channels CH 1, CH 2, . . . , CH N, such as a dichroic mirror or other optical filter(s), for instance.

The combined light signal/spectrum may then be directed to the CEPAS detector and allowed to interact with a sample provided in the sample cell 106. A signal provided at the CEPAS detector at a first frequency Mod 1 then essentially corresponds to the signal caused by a constituent (or constituents) of the sample that absorbs the light at wavelengths provided in the first channel CH 1, while a signal provided at the second frequency Mod 2 essentially corresponds to the signal caused by a constituent (or constituents) of the sample that absorbs the light at wavelengths provided in the second channel CH 2.

In the case of simultaneously detecting NO₂ via a first channel CH 1 and black carbon via a second channel CH 2, the signal at the first frequency Mod 1 essentially corresponds to the signal provided by both NO₂ and black carbon absorbing the provided wavelengths of light and the signal at the second frequency Mod 2 essentially corresponds to the signal provided by only black carbon because NO₂ will essentially not absorb the wavelengths of light in the second channel CH 2.

Due to the used electromagnetic radiation being provided by a common light source 102 and the effect of each channel being measured/detected simultaneously, some common disturbances that could interfere with the signal may be compensated for and cancelled out. For instance, a fluctuation of the light power/intensity provided by the light source 102 or light absorbed by the opening and/or walls of the sample cell 106 could lead to background that disturbs the measurements.

In one embodiment, a plurality of channels may be provided by an apparatus 100 that is configured to detect only one compound comprised in a sample. Here, the apparatus may provide a signal where a possibly fluctuating background is reduced or eliminated due to the above compensation of disturbances. If only one channel is used, e.g. to detect NO₂, a detection threshold as a function of averaging time may be over ppb. Yet, when using two channels (a first channel comprising wavelengths of e.g. 400-500 nm and second channel comprising other wavelengths), the detection threshold may be lowered to under ppb with longer averaging times because a fluctuation in background disturbances may be essentially eliminated.

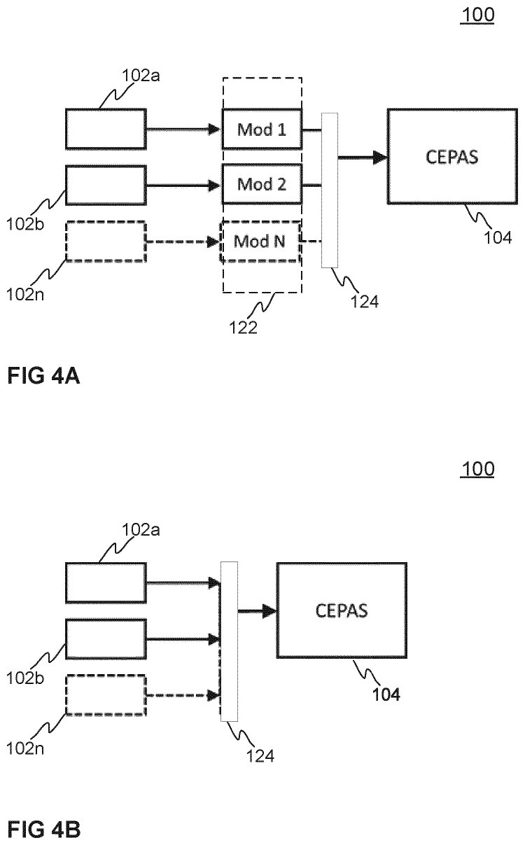

FIG. 4A schematically shows at least a portion of one further embodiment of an apparatus 100 according to the present invention. Here, the apparatus 100 may comprise a plurality of light sources 102a, 102b, . . . , 102n. The light sources 102a, 102b, . . . , 102n may comprise e.g. LEDs, SLDs, supercontinuums, and/or frequency combs. Each light source 102a, 102b, . . . , 102n may be comprised to provide a spectrum of electromagnetic radiation, where each spectrum may be different. The spectra may be overlapping or discrete. Here, the separation of the spectra using dedicated means 120 is not necessary.

The separate channels or spectra provided by the light sources 102a, 102b, . . . , 102n may be directed to means 122 for modulating each spectrum, preferably at a different frequency. Modulation means 122 may comprise e.g. previously discussed optical choppers 002. For example, Mod 1 may be associated with a first optical chopper, Mod 2 may be associated with a second optical chopper and so forth.

The apparatus 100 may then be configured to join the spectra together, e.g. the apparatus may comprise means 124 comprising for instance a dichroic mirror to combine the light channels, and direct the resulting light to a CEPAS detector 104.

FIG. 4B shows a simplified view of an alternative embodiment of an apparatus 100 comprising a plurality of non-thermal broadband light sources 102a, 102b, . . . , 102n. If the spectrum provided by each light source is essentially discrete or the spectra do not overlap significantly, the light provided by each light source 102a, 102b, . . . , 102n may be modulated by periodically varying or pausing the current being provided to each light source separately, at differing modulation frequencies to provide the modulated light channels/spectra, which may be combined by the combining means 124 before being passed to the CEPAS detector 104.

The apparatus 100 and method for analyzing a sample provided by this embodiment may be very simple and cost effective, because there may be no need for providing dedicated means 122 for modulating the light.

The CEPAS detector 104 in the embodiments of FIGS. 3, 4A, and 4B may essentially correspond to that which may be used in the embodiment of FIG. 1.

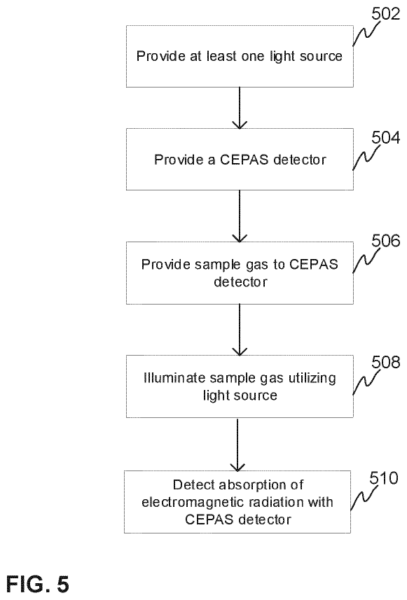

FIG. 5 shows a flow chart of a method for analyzing a sample according to an embodiment of the present invention. At least one light source is provided 502, where the light source is configured to emit non-thermal broadband electromagnetic radiation. A cantilever-enhanced photoacoustic (CEPAS) detector is then provided 504.

The CEPAS detector is provided 506 with a sample gas to be analyzed, after which the sample gas is illuminated with the electromagnetic radiation provided by the light source. Finally, absorption of said electromagnetic radiation by the sample is detected 510 with the CEPAS detector.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. An apparatus for analyzing a sample, wherein the apparatus comprises:
at least one light source configured to emit non-thermal broadband electromagnetic radiation towards a sample and
a cantilever-enhanced photoacoustic (CEPAS) detector configured to receive the sample and the electromagnetic radiation and detect absorption of said electromagnetic radiation by the sample.

2. The apparatus of claim 1, wherein the CEPAS detector comprises:
a sample chamber adapted to receive the sample, the sample chamber comprising at least one opening for allowing the electromagnetic radiation to enter the sample chamber and
a microphone arrangement comprising
at least one aperture arranged in the sample chamber, said aperture having a cantilever coupled thereto, wherein the cantilever preferably comprises silicon, and is configured to be movable in response to pressure variations occurring in the sample chamber due to said electromagnetic radiation being absorbed by the sample, and
a measuring arrangement for measuring the movement of the cantilever.

3. The apparatus of claim 1, wherein the spectrum of electromagnetic radiation emitted by the at least one light source comprises a bandwidth of at least 1 THz.

4. The apparatus of claim 1, wherein the at least one light source is a light emitting diode (LED), superluminescent diode (SLD), supercontinuum light source, or optical frequency comb.

5. The apparatus of claim 1, wherein the apparatus additionally comprises means for modulating the electromagnetic radiation with at least one frequency, optionally in the range of 10 Hz-5 kHz.

6. The apparatus of claim 3, wherein the means for modulating comprises at least one optical chopper or the modulating comprises modulating electric current being passed to the at least one light source.

7. The apparatus of claim 1, wherein the apparatus is configured to provide a plurality of discrete or at least partially overlapping separate spectra of electromagnetic radiation separable into a plurality of different channels.

8. The apparatus of claim 7, wherein the separate spectra are provided by dedicated means, optionally using one or more optical filters, or the separate spectra are provided by using a plurality of light sources.

9. The apparatus of claim 7, wherein the apparatus is configured to modulate at least two of the separate spectra, preferably all of those provided, at different frequencies.

10. The apparatus of claim 7, wherein the apparatus additionally comprises means for combining the separate spectra and the CEPAS detector is configured to receive the combined spectrum.

11. The apparatus of claim 7, wherein the apparatus is configured to simultaneously detect at least one first compound, preferably at least one species of particulate matter, optionally black carbon, and at least one second compound, preferably at least one gaseous compound, optionally a nitrogen oxide by selecting the separate spectra such that at least one of said spectra comprises wavelengths that are essentially absorbed by the first compound and at least one other of said spectra comprises wavelengths that are essentially not absorbed by the first compound.

12. A method of analyzing a sample, the method comprising:
providing at least one light source configured to emit non-thermal broadband electromagnetic radiation,
providing a cantilever-enhanced photoacoustic (CEPAS) detector,
providing the CEPAS detector with a sample gas to be analyzed,
illuminating the sample gas with said electromagnetic radiation, and
detecting absorption of said electromagnetic radiation by the sample with the CEPAS detector.

13. The apparatus of claim 8, wherein the apparatus is configured to modulate at least two of the separate spectra, preferably all of those provided, at different frequencies.

14. The apparatus of claim 8, wherein the apparatus additionally comprises means for combining the separate spectra and the CEPAS detector is configured to receive the combined spectrum.

15. The apparatus of claim 8, wherein the apparatus is configured to simultaneously detect at least one first compound, preferably at least one species of particulate matter, optionally black carbon, and at least one second compound, preferably at least one gaseous compound, optionally a nitrogen oxide by selecting the separate spectra such that at least one of said spectra comprises wavelengths that are essentially absorbed by the first compound and at least one other of said spectra comprises wavelengths that are essentially not absorbed by the first compound.
